(19) United States
(12) Patent Application Publication
(10) Pub. No.: US 2020/0005826 A1
(43) Pub. Date: Jan. 2, 2020

(54) SPINDLE MOTOR

(71) Applicant: MINEBEA MITSUMI Inc., Nagano (JP)

(72) Inventors: Hideaki SHOWA, Kitasaku-gun (JP); Tadashi AKAHORI, Kitasaku-gun (JP)

(21) Appl. No.: 16/454,266

(22) Filed: Jun. 27, 2019

(30) Foreign Application Priority Data
Jun. 29, 2018 (JP) 2018-125562

(51) Int. Cl. G11B 19/20; F16C 33/72; H02K 15/14; H02K 5/04

(52) U.S. Cl. CPC G11B 19/2009; F16C 33/72; F16C 2370/12; H02K 5/04; F16C 2226/40; H02K 15/14

(57) ABSTRACT

A spindle motor according to one aspect of the present disclosure includes a shaft member, a baseplate having a through hole in which the shaft member is inserted and fixed, and a rotor member disposed on one side in an axial direction of the baseplate and rotatably supported through the shaft member. In a peripheral groove formed in an inner peripheral surface of the through hole, a gap between the shaft member and the baseplate is sealed by adhesive on the one side in the axial direction and the other side in the axial direction opposite to the one side, so that a confined volume of air is formed.

### CROSS REFERENCE TO RELATED APPLICATIONS

This application claims the benefit of Japanese Patent Application No. 2018-125562, filed Jun. 29, 2018, which is hereby incorporated by reference in its entirety.

### BACKGROUND

### Technical Field

The present disclosure relates to a spindle motor.

### Background

In some hard disk drives for driving hard disks, gas lighter than air such as helium gas is sealed in an interior space of a case. In the hard disk drive, a cured adhesive provides a seal between a shaft member and a through hole formed in a baseplate composing the case, to prevent the gas from leaking out of the through hole (for example, see Japanese Patent Laid-Open No. 2012-152098).

The hard disk drives are demanded to control rotation of the disks, movement of magnetic heads, and so on to increase the storage capacity. The gas such as helium gas is sealed in the interior space of the case of the hard disk drive to reduce the resistance of the gas against the hard disk, the magnetic head, and so on during rotation of a spindle motor. This contributes to reducing vibration of the hard disk, the magnetic head, and so on, thereby enabling highly precise data recording.

However, the gas such as helium gas, which has smaller molecules than air, may leak out of a gap between the shaft member and the through hole of the baseplate to the outside of the hard disk drive. Therefore, the sealing performance between the baseplate and the shaft member is required to be sufficiently high when the shaft member is fixed to the through hole of the baseplate.

The present disclosure is related to providing a technique for improving the sealing performance between a through hole of a baseplate and a shaft member inserted into the through hole.

### SUMMARY

A spindle motor according to one aspect of the present disclosure includes a shaft member, a baseplate having a through hole in which the shaft member is inserted and fixed, and a rotor member disposed on one side in an axial direction of the baseplate and rotatably supported through the shaft member. In a peripheral groove formed in an inner peripheral surface of the through hole, a gap between the shaft member and the baseplate is sealed by an adhesive on one side in the axial direction and the other side in the axial direction, so that a confined volume of air is formed.

With the spindle motor according to the present disclosure, the sealing performance between the through hole of the baseplate and the shaft member inserted into the through hole can be improved.

### BRIEF DESCRIPTION OF THE DRAWINGS

FIG. 1 is a perspective view for illustrating a schematic configuration of a hard disk drive according to an embodiment of the present disclosure.

FIG. 2 is a cross-sectional view schematically illustrating a configuration of a spindle motor illustrated in FIG. 1.

FIG. 3 is a partially enlarged cross-sectional view schematically illustrating a configuration of a lower portion of the spindle motor illustrated in FIG. 2.

FIG. 4 is a diagram for illustrating a method of attaching a shaft member to a baseplate in the spindle motor according to an embodiment of the present disclosure.

FIG. 5 is a diagram for illustrating a method of attaching the shaft member to the baseplate in the spindle motor according to the embodiment of the present disclosure.

FIG. 6 is a partially enlarged cross-sectional view schematically illustrating a configuration of a variant of a lower portion of the spindle motor according to the embodiment of the present disclosure illustrated in FIG. 2.

### DETAILED DESCRIPTION

Hereinafter, embodiments of the present disclosure will be described with reference to the drawings.

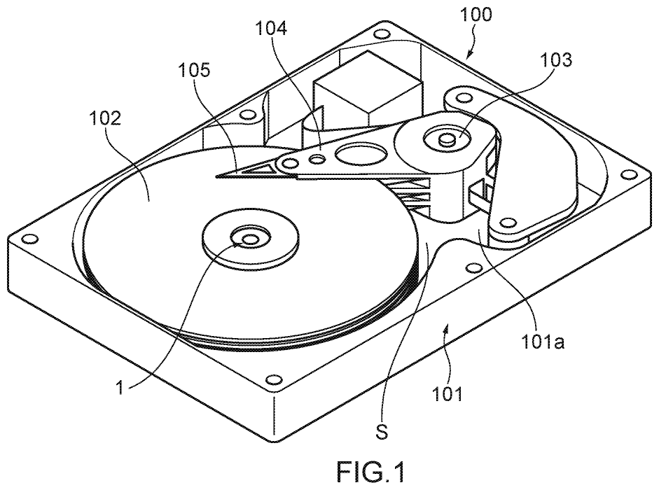

FIG. 1 is a perspective view for illustrating a schematic configuration of a hard disk drive 100 to which a spindle motor 1 according to an embodiment of the present disclosure is applied. In the hard disk drive 100, the spindle motor 1 is fixed to a bottom portion 101a of a housing 101, and the spindle motor 1 rotatably supports a magnetic disk 102. A case of the hard disk drive 100 is formed by a cover (not illustrated) and the housing 101. An interior space S formed by the cover (not illustrated) and the housing 101 is filled with gas (for example, helium gas, nitrogen gas, a mixture of helium and nitrogen gases, or the like) having a density lower than that of air.

In the hard disk drive 100, a magnetic head 105 disposed at a tip end of a swing arm 104 moves on the magnetic disk 102 being rotated, the swing arm 104 being swingably supported by a bearing device 103. Thereby, the magnetic head 105 can record information on the magnetic disk 102, and read the information recorded in the magnetic disk 102.

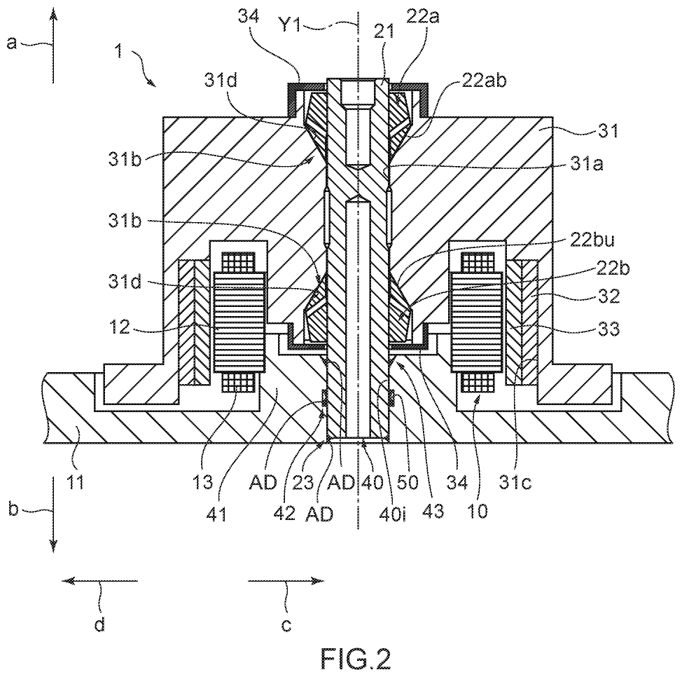

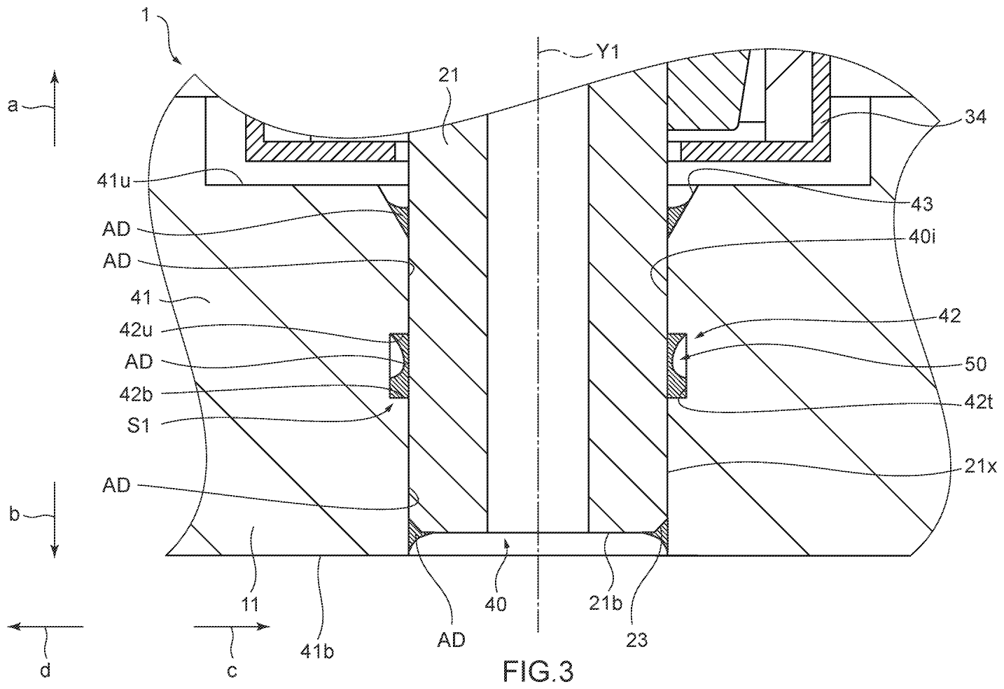

FIG. 2 is a cross-sectional view schematically illustrating a configuration of the spindle motor 1 illustrated in FIG. 1. FIG. 3 is a partially enlarged cross-sectional view schematically illustrating a configuration of a lower portion of the spindle motor 1 illustrated in FIG. 2. Hereinafter, for the convenience in description, in FIG. 2, one side (in the direction of the arrow a) in a direction of an axis Y1 (hereinafter referred to as axial direction) of the spindle motor 1 is assumed to be an upper side (one side in the axial direction), and the other side (in the direction of the arrow b) is assumed to be a lower side (the other side in the axial direction). Furthermore, in FIG. 2, one side (in the direction of the arrow c) in a radial direction extending perpendicular to the axis Y1 of the spindle motor 1 is assumed to be the radially inner side, and the other side (in the direction of the arrow d) is assumed to be the radially outer side. Relative positions or directions of different members used in the following description to make the description are simply used with reference to the accompanying drawings, and should not be construed as describing the relative positions or directions of those members when actually installed in an apparatus.

The spindle motor 1 according to an embodiment of the present disclosure includes a shaft member 21, a baseplate 11, and a rotor member 31. The baseplate 11 has a through hole 40 in which the shaft member 21 is inserted and fixed. The rotor member 31 is disposed on one side (an upper side (in the direction of the arrow a)) in the axial direction of the baseplate 11, and is rotatably supported through the shaft member 21. In a peripheral groove 42 formed in an inner peripheral surface 40i of the through hole 40, a gap between the shaft member 21 and the baseplate 11 is sealed with an adhesive AD on the one side in the axial direction and on the other side (a lower side (in the direction of the arrow b)) opposite to the one side so that a confined volume of air 50 is formed. Hereinafter, a configuration of the spindle motor 1 will be specifically described.

As illustrated in FIG. 2, the spindle motor 1 includes a stator 10, the shaft member 21, and the rotor member 31. The stator 10 includes a stator core 12 fixed to the baseplate 11. The baseplate 11 is provided with the through hole 40 in which an end portion on the lower side of the shaft member 21 and a circumferential wall portion 41 concentric with the through hole 40. The stator core 12 is formed to the outer peripheral surface of the circumferential wall portion 41, and a coil 13 is wound around the stator core 12.

The through hole 40 is formed in a cylindrical shape extending in the axial direction centered about the axis Y1. As illustrated in FIG. 3, the through hole 40 penetrates an upper surface 41u that is a surface on an upper side of the circumferential wall portion 41 and a lower surface 41b that is a surface on a lower side of the circumferential wall portion 41. The through hole 40 has the peripheral groove 42 that is recessed radially outward (in the direction of the arrow d) from the inner peripheral surface 40i.

More specifically, the peripheral groove 42 of the through hole 40 is annularly recessed toward the radially outside from the inner peripheral surface 40i of the through hole 40 at a center portion in the axial direction of the through hole 40. Furthermore, the peripheral groove 42 of the through hole 40 is formed in a rectangular shape in a cross-sectional view, the rectangular shape having a long side in the axial direction and a short side in the radial direction.

The peripheral groove 42 of the through hole 40 has a bottom surface 42t that is a cylindrical surface extending along the axial direction centered about the axis Y1, the bottom surface 42t being located at a predetermined depth position on the radially outer side from the inner peripheral surface 40i of the through hole 40. The bottom surface 42t defines a boundary of the radially outer side of the peripheral groove 42.

An upper surface 42u is formed on the upper side of the bottom surface 42t of the peripheral groove 42. The upper surface 42u of the peripheral groove 42 is a surface defining a boundary on the upper side of the peripheral groove 42. The upper surface 42u of the peripheral groove 42 is an annular surface extending radially inward from the edge on the upper side of the bottom surface 42t and along the radial direction centered about the axis Y1.

A lower surface 42b is formed on the lower side of the bottom surface 42t of the peripheral groove 42. The lower surface 42b of the peripheral groove 42 is a surface defining a boundary on the lower side of the peripheral groove 42. The lower surface 42b of the peripheral groove 42 is an annular surface extending radially inward from the edge on the lower side of the bottom surface 42t and along the radial direction centered about the axis Y1.

The through hole 40 includes a diameter expanding portion (inclined surface 43) that gradually increases in diameter toward one side (an upper side) in the axial direction, the diameter expanding portion being provided at an end portion on one side in the axial direction. More specifically, as illustrated in FIG. 3, the annular inclined surface 43 is formed at a corner on the inner peripheral side at an end portion on the upper side of the through hole 40. The inclined surface 43 extends toward the inner peripheral side and diagonally downward from the upper surface 41u of the circumferential wall portion 41. The edge on the lower side of the inclined surface 43 is connected with the edge on the upper side of the inner peripheral surface 40i of the through hole 40.

As illustrated in FIG. 2, the spindle motor 1 includes the shaft member 21, and an upper conical bearing member 22a and a lower conical bearing member 22b that are fixed to the shaft member 21. The shaft member 21 is formed in a substantially cylindrical shape, and is made of, for example, SUS420J2 that is martensitic stainless steel.

The shaft member 21 includes a diameter decreasing portion (inclined surface 23) that gradually decreases in diameter toward the other side (a lower side) in the axial direction, the diameter decreasing portion being provided at an end portion on the other side in the axial direction. More specifically, as illustrated in FIG. 3, the annular inclined surface 23 is formed at a corner on the outer peripheral side at an end portion on the lower side of the shaft member 21. The inclined surface 23 extends toward the outer peripheral side and diagonally upward from the lower surface 21b that is a surface on the lower side of the shaft member 21. The edge on the upper side of the inclined surface 23 is connected with the edge on the lower side of the outer peripheral surface 21x of the shaft member 21.

As illustrated in FIG. 2, the shaft member 21 is inserted into a through hole 31a formed in the rotor member 31. The end portion on the lower side of the shaft member 21 is inserted and fixed in the through hole 40 formed in the baseplate 11. Each of the upper conical bearing member 22a and the lower conical bearing member 22b is provided to surround the periphery of the shaft member 21, and is made of, for example, SUS303 that is austenitic stainless steel.

The spindle motor 1 includes the rotor member 31, a yoke 32, a rotor magnet 33, and an end cap 34. The rotor member 31 is formed in a substantially cylindrical shape, and is made of, for example, an aluminum alloy A6061-T6. The through hole 31a for inserting the shaft member 21 therethrough, two dynamic pressure generating groove portions 31b, and a yoke attachment portion 31c are formed in the rotor member 31. The rotor magnet 33 is fixed to the yoke attachment portion 31c through the yoke 32. The rotor magnet 33 is made of a permanent magnet, and is disposed to face the stator core 12.

The dynamic pressure generating groove portions 31b are formed on the inner peripheral surface of the through hole 31a and at positions facing the upper conical bearing member 22a and the lower conical bearing member 22b, respectively. The dynamic pressure generating groove portions 31b each are provided with a dynamic pressure generating groove (not illustrated) for generating a dynamic pressure. The dynamic pressure generating groove can be formed by performing the electrochemical machining on a conical inner surface 31d provided on each of the upper side and the lower side of the through hole 31a in the rotor member 31. The conical inner surfaces 31d face a lower-side conical outer surface 22ab that is an outer peripheral surface on the lower side of the upper conical bearing member 22a and, and an upper-side conical outer surface 22bu that is an outer peripheral surface on the upper side of the lower conical bearing member 22b, respectively, with a minute gap therebetween. In the spindle motor 1, the minute gaps are filled with lubricating oil to form fluid dynamic bearings (conical fluid dynamic bearings).

The end cap 34 is a member fixed to the rotor member 31. A small gap is formed between the end cap 34 and the shaft member 21 so that the rotation of the rotor member 31 is not prevented by the end cap 34. The end cap 34 is fixed to the rotor member 31 by bonding, or bonding and press-fitting.

The rotor magnet 33 fixed to the rotor member 31 faces the stator core 12 fixed to the stator 10 with a small gap therebetween. The driving currents of different phases flow in a plurality of coils 13 of the stator 10 to generate the rotating magnetic field, so that a rotational force is generated in the rotor magnet 33 by this rotating magnetic field. Thus, the rotor member 31 rotates with respect to the stator 10 and the shaft member 21.

When the rotor member 31 rotates with respect to the shaft member 21, the dynamic pressure generating grooves of the respective dynamic pressure generating groove portions 31b generate the dynamic pressure for spacing the lower conical outer surface 22ab of the upper conical bearing member 22a and the upper conical outer surface 22bu of the lower conical bearing member 22b from the respective corresponding conical inner surfaces 31d of the rotor member 31. Thus, the conical inner surfaces 31d are supported without contacting the lower-side conical outer surface 22ab and the upper-side conical outer surface 22bu, respectively. When the conical inner surfaces 31d are supported without contacting the lower-side conical outer surface 22ab and the upper-side conical outer surface 22bu, respectively, the rotor member 31 freely rotates relative to the stator 10 fixed to the shaft member 21.

The end portion on the lower side of the shaft member 21 is fixed to the through hole 40 of the baseplate 11 by the cured adhesive AD. Within the peripheral groove 42 of the baseplate 11, the confined volume of air 50 is formed between the cured adhesion AD and the bottom surface 42t of the peripheral groove 42 over the entire circumference of the peripheral groove 42.

More specifically, as illustrated in FIG. 3, the confined volume of air 50 is formed in a space S1 defined by the peripheral groove 42 of the through hole 40 and the outer peripheral surface 21x of the shaft member 21. The confined volume of air 50 is formed radially inward (in the direction of the arrow c) from the bottom surface 42t of the peripheral groove 42 at a center portion in the axial direction of the space S1. That is, the confined volume of air 50 has a curved surface protruding like bulging radially inward, and is formed in an annular shape over the entire circumference of the peripheral groove 42. In the peripheral groove 42, the adhesive AD for sealing the gap between the shaft member 21 and the baseplate 11 contacts the outer peripheral surface 21x of the shaft member 21 while being continuous between the upper side and the lower side of the peripheral groove 42 in the axial direction. In other words, the upper portion of the adhesive AD sealing the upper side of the peripheral groove 42 and the lower portion of the adhesive AD sealing the lower side of the peripheral groove 42 connect to the each other on the outer peripheral surface 21x of the shaft member 21. The adhesive AD seals the gap between the shaft member 21 and the baseplate to prevent the outer peripheral surface 21x of the shaft member 21 from being exposed in the peripheral groove 42, thereby improving the sealing performance.

In addition, on the other side (lower side) in the axial direction within the diameter expanding portion (inclined surface 43), the adhesive AD seals the gap between the shaft member 21 and the baseplate 11. Furthermore, the adhesive AD seals the gap between one side (upper side) in the axial direction of the diameter decreasing portion (inclined surface 23) of the shaft member 21 and the baseplate 11. That is, the cured adhesive AD is also provided between the shaft member 21 and the inclined surface 43 of the through hole 40 of the baseplate 11, and between the inclined surface 23 of the shaft member 21 and the inner peripheral surface 40i of the through hole 40.

More specifically, the cured adhesive AD between the shaft member 21 and the inclined surface 43 of the through hole 40 is provided from the edge on the lower side of the inclined surface 43 of the through hole 40 to a predetermined position of the inclined surface 43 of the through hole 40 in the axial direction. Furthermore, the cured adhesive AD is also provided between the inclined surface 23 of the shaft member 21 and the inner peripheral surface 40i of the through hole 40, and spreads in the inclined surface 23 of the shaft member 21 and a portion of the lower side of the through hole 40.

The cured adhesive AD is also provided between the outer peripheral surface 21x of the shaft member 21 and the inner peripheral surface 40i of the through hole 40 of the baseplate 11. More specifically, the cured adhesive AD is also provided between the outer peripheral surface 21x of the shaft member 21 and the inner peripheral surface 40i of the through hole 40 located on the upper side of the peripheral groove 42. Furthermore, the cured adhesive AD is provided between the outer peripheral surface 21x of the shaft member 21 and the inner peripheral surface 40i of the through hole 40 located on the lower side of the peripheral groove 42.

The resin agent that is cured by heating is used for the adhesive AD, and for example, an epoxy-based thermosetting adhesive is used.

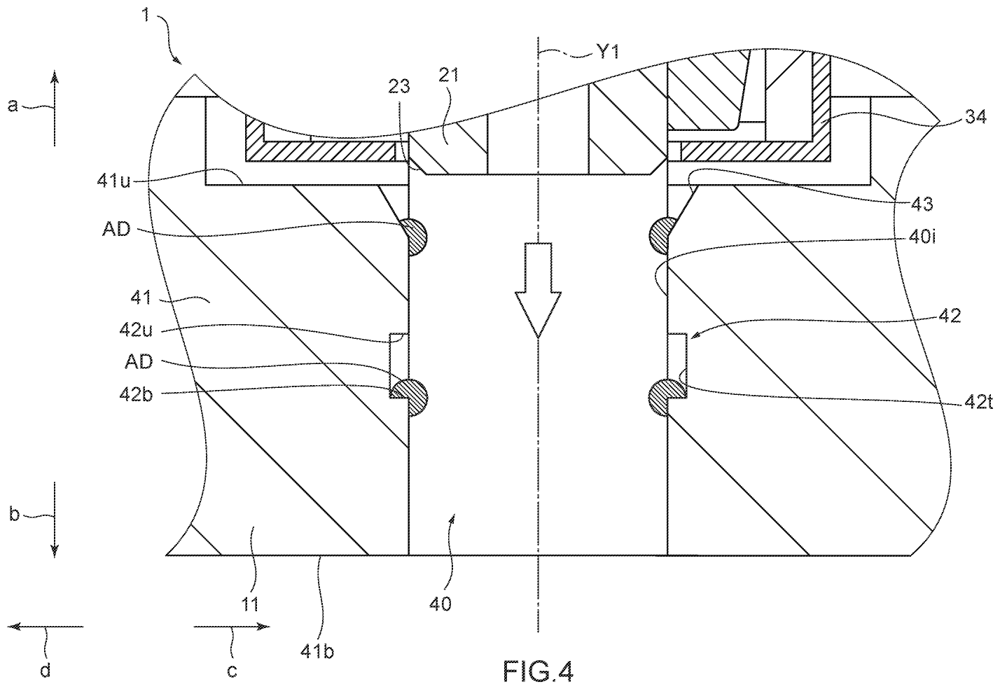

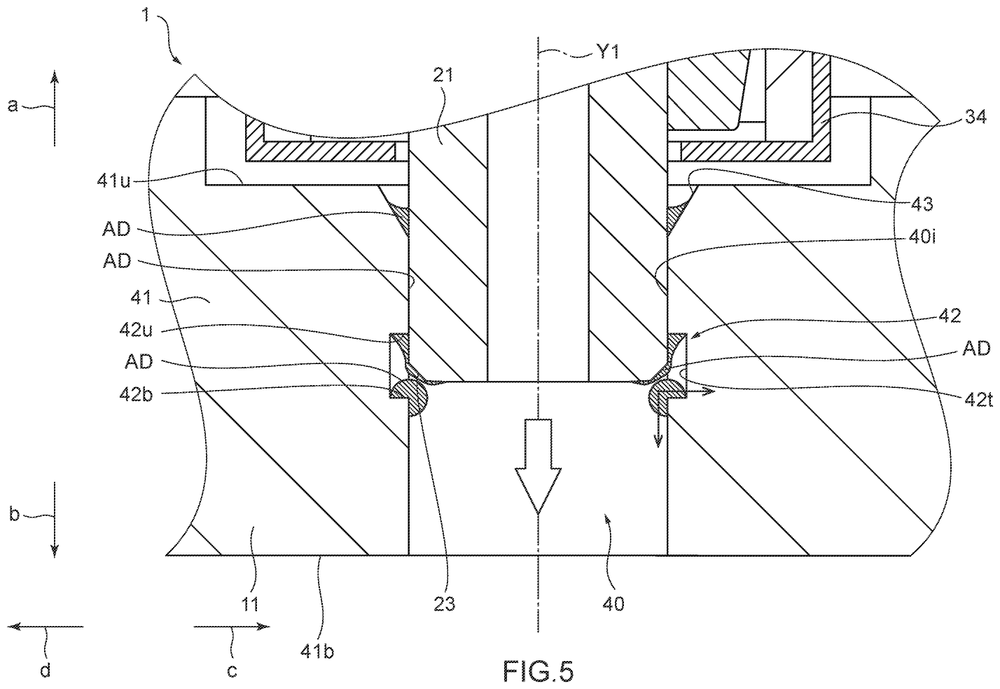

Next, a method of attaching the shaft member 21 to the baseplate 11 in the spindle motor 1 having the above-described configuration will be described. FIGS. 4 and 5 each is a diagram for illustrating a method of attaching the shaft member 21 to the baseplate 11 in the spindle motor 1 according to an embodiment of the present disclosure. The adhesive AD is annularly applied to the end portion on the lower side of the inclined surface 43 and the end portion of the inner peripheral surface 40i of the through hole 40 that connects to the edge of the inclined surface 43 on the lower side in the form of an arc as viewed in cross section. Furthermore, the adhesive AD is annularly applied to the lower surface 42b of the peripheral groove 42 of the through hole 40 and the end portion of the inner peripheral surface 40i of the through hole 40 that connects to the edge of the lower surface 42b on the lower side in the form of an arc as viewed in cross section.

As illustrated in FIG. 4, the shaft member 21 is inserted from the upper side of the through hole 40 of the baseplate 11 toward the lower side from the upper side. Then, as illustrated in FIG. 5, the shaft member 21 contacts the adhesive AD on the upper side, and further moves downward. At this time, a part of the adhesive AD on the upper side is extruded into between the shaft member 21 and the inclined surface 43 of the through hole 40. Furthermore, a part of the adhesive AD on the upper side is spread downward following the movement of the shaft member 21.

When the shaft member 21 reaches the proximity of the peripheral groove 42 of the through hole 40, the adhesive AD on the upper side forced to follow the shaft member 21 is pushed toward the bottom surface 42t of the peripheral groove 42 at the upper side of the peripheral groove 42. Subsequently, the shaft member 21 contacts the adhesive AD on the lower side, and moves further downward. At this point, as illustrated in FIG. 5, the adhesive AD on the lower side (the lower surface 42b side) is divided into two parts, so that one part of the adhesive AD is pushed toward the bottom surface 42t of the peripheral groove 42, and the remaining part thereof is extruded to the lower side of the through hole 40 following the movement of the shaft member 21.

Here, a gap between the shaft member 21 and the inner peripheral surface 40i of the through hole 40 located on the upper side of the peripheral groove 42 of the through hole 40 is sealed with the adhesive AD. Therefore no escape for the air is provided on the upper side of the peripheral groove 42 of the through hole 40 and a certain volume of air is confined in the peripheral groove 42. Consequently, the confined volume of air 50 is formed in the peripheral groove 42 of the through hole 40.

Thus, the spindle motor 1 according to the embodiment of the present disclosure includes the peripheral groove 42 that is recessed radially outward from the inner peripheral surface 40i of the through hole 40. Furthermore, in the peripheral groove 42, the confined volume of air 50 is formed between the cured adhesion AD and the bottom surface 42t of the peripheral groove 42 over the entire circumference of the peripheral groove 42.

When the adhesive AD is an epoxy-based thermosetting adhesive, the confined volume of air 50 formed in the space 51 expands by heat when curing the adhesive AD. Thus, the confined volume of air 50 formed over the entire circumference of the peripheral groove 42 can push the adhesive AD in the peripheral groove 42 radially inward (in the direction of the arrow c). Accordingly, the sealing performance between the shaft member 21 and the through hole 40 of the baseplate 11 can be improved.

In the spindle motor 1 according to the embodiment of the present disclosure, the cured adhesive AD is provided between the shaft member 21 and the inclined surface 43 of the through hole 40 as well as between the inclined surface 23 of the shaft member 21 and the through hole 40. Furthermore, the adhesive AD is also provided between the outer peripheral surface 21x of the shaft member 21 and the inner peripheral surface 40i of the through hole 40. Accordingly, the sealing performance between the shaft member 21 and the through hole 40 of the baseplate 11 can be further improved by the cured adhesive AD.

Although an embodiment of the present disclosure has been described above, the present disclosure is not limited to the embodiment described above, and includes all aspects that fall within the concepts of the present disclosure and the claims. In addition, the respective components may be selectively combined as appropriate in order to achieve at least part of the above-described effects. For example, the shape, materials, arrangement, size, and the like of each constituent element in the above embodiment can be appropriately modified according to the specific usage mode of the present disclosure.

In the spindle motor 1 according to an embodiment of the present disclosure, although an example where the peripheral groove 42 of the through hole 40 formed in a rectangular shape in a cross-sectional view has been described, the present disclosure is not limited thereto. The peripheral groove 42 may be of various different shapes in the cross-sectional view. For example, the peripheral groove 42 may have a triangular shape in the cross-sectional view or a semicircular shape in the cross-sectional view. When the peripheral groove 42 of the through hole 40 has a triangular shape in the cross-sectional view or a semicircular shape in the cross-sectional view, the adhesive AD flows into the smaller diameter side of the upper side and the lower side by capillary phenomenon. Accordingly, the sealing performance between the shaft member 21 and the through hole 40 of the baseplate 11 can be improved. Alternatively, a plurality of peripheral grooves 42 may be provided in the through hole 40 at desired intervals in the axial direction.

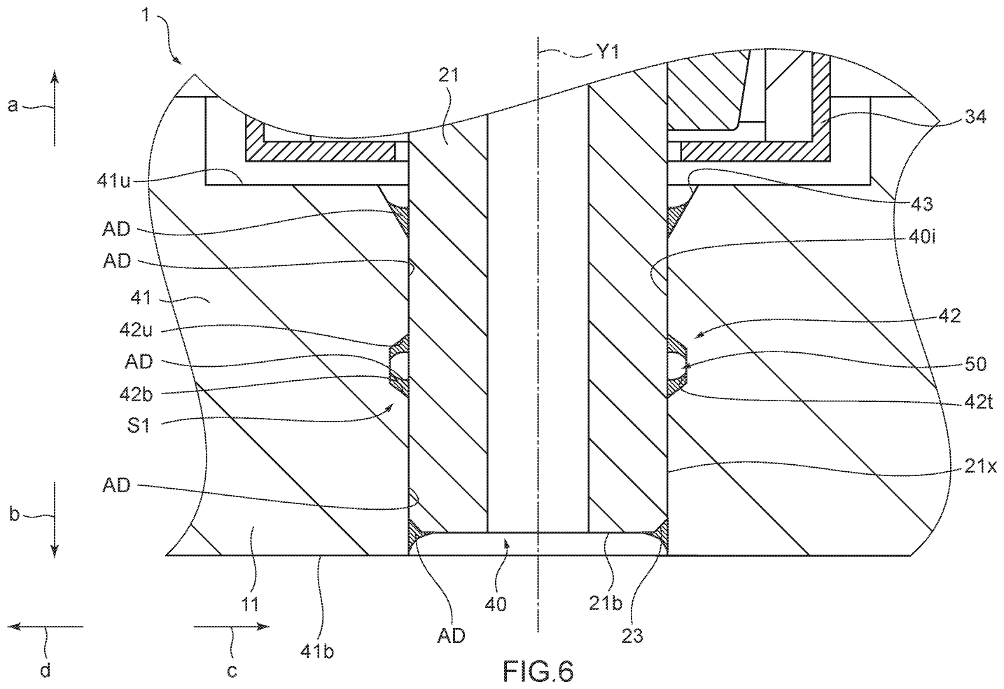

For example, as illustrated in FIG. 6, the peripheral groove 42 of the through hole 40 may have a trapezoidal shape in the cross-sectional view. FIG. 6 is a partially enlarged cross-sectional view schematically illustrating a configuration of a variant of a lower portion of the spindle motor 1 according to the embodiment of the present disclosure illustrated in FIG. 2. More specifically, the upper surface 42u of the peripheral groove 42 extends from the edge on the upper side of the bottom surface 42t inclined upward and radially inward. In other words, the inner diameter of the upper surface 42u gradually decreases toward the upper side in the axial direction. The lower surface 42b of the peripheral groove 42 extends from the edge on the lower side of the bottom surface 42t inclined downward and radially inward. In other words, the inner diameter of the upper surface 42t gradually decreases toward the lowe side in the axial direction. .

The confined volume of air 50 protrudes to bulge radially inward (in the direction of the arrow c) from the bottom surface 42t to reach the outer peripheral surface 21x of the shaft member 21, and is formed in an annular shape over the entire circumference of the peripheral groove 42. That is, in the peripheral groove 42, the upper portion of the adhesive AD sealing the gap between the shaft member 21 and the baseplate 11 on the upper side and the lower portion of the adhesive AD sealing the gap between the shaft member 21 and the baseplate 11 on the lower side contact the outer peripheral surface 21x of the shaft member 21 without being connected to each other. Even in such a case, the adhesive AD flows into the smaller diameter side of the upper side (in the direction of the arrow a) and the lower side (in the direction of the arrow b) by capillary phenomenon. Accordingly, the sealing performance between the shaft member 21 and the through hole 40 of the baseplate 11 can be improved.

In the spindle motor 1 according to an embodiment of the present disclosure, an example has been described where the confined volume of air 50 is formed over the entire circumference of the peripheral groove 42 between the adhesion AD cured in the peripheral groove 42 and the bottom surface 42t of the peripheral groove 42. However, the present disclosure is not limited thereto, and instead of only one confined volume of air 50 formed over the entire circumference, a plurality of confined volume of airs 50 may be formed.

What is claimed is:

1. A spindle motor comprising:
a shaft member;
a baseplate having a through hole in which the shaft member is inserted and fixed; and
a rotor member disposed on one side in an axial direction of the baseplate and rotatably supported through the shaft member,
wherein in a peripheral groove formed in an inner peripheral surface of the through hole, a gap between the shaft member and the baseplate is sealed by an adhesive on a one side in the axial direction and on an other side in the axial direction opposite to the one side, so that a confined volume of air is formed.

2. The spindle motor according to claim 1, wherein
the through hole includes a diameter expanding portion that gradually increases in diameter toward the one side in the axial direction, the diameter expanding portion being provided at an end portion of the through hole on the one side in the axial direction, and
on the other side in the axial direction within the diameter expanding portion, the gap between the shaft member and the baseplate is sealed by the adhesive.

3. The spindle motor according to claim 1, wherein
the shaft member includes a diameter decreasing portion that gradually decreases in diameter toward the other side in the axial direction, the diameter decreasing portion being provided at an end portion of the shaft member on the other side in the axial direction, and
the gap between the one side in the axial direction of the diameter decreasing portion and the baseplate is sealed by the adhesive.

4. The spindle motor according to claim 1, wherein
in the peripheral groove, the adhesive sealing the gap between the shaft member and the baseplate contacts an outer peripheral surface of the shaft member while being continuous between the one side in the axial direction and the other side in the axial direction.
